(19) United States
(12) Patent Application Publication
(10) Pub. No.: US 2004/0216442 A1
(43) Pub. Date: Nov. 4, 2004

(54) Tree shaker apparatus

(76) Inventor: Richard A. Briesemeister, Clear Lake, WI (US)

Correspondence Address: MERCHANT & GOULD PC, P.O. BOX 2903, MINNEAPOLIS, MN, 55402-0903, US

(21) Appl. No.: 10/428,315

(22) Filed: May 2, 2003

(51) Int. Cl. A01D 46/00

(52) U.S. Cl. 56/340.1

(57) ABSTRACT

A shaker device for use on a harvester to remove and gather produce from a plant. The shaker device is configured to be mounted adjacent to a conveyor assembly of a harvester. The shaker device is arranged and configured to contact and engage the lowermost branches of an untrimmed tree or plant to remove produce from the lowermost branches of the untrimmed tree or plant.

### TECHNICAL FIELD

The present invention relates to harvesting systems and apparatuses, and more particularly, to harvesting systems and apparatuses used to mechanically harvest fruit.

### BACKGROUND

Mechanized harvesters are well known and provide several advantages over traditional manual harvesting methods. One of the advantages provided by mechanized harvesters is that the time required to remove and gather produce from each of the plants is significantly reduced. Likewise, the overall cost of removing and gathering the produce from each of the plants is significantly reduced. Because of these advantages, the use of mechanized harvesters to harvest fruit, or other produce from various plants, such as trees or vines, has increased considerably.

One such mechanized harvester is disclosed in U.S. Pat. No. 6,463,725, which is herein incorporated by reference. This mechanized harvester includes a conveyor system arranged to catch produce as it falls from the plant. The produce is removed from the plant, for example, by an agitator constructed and arranged to engage the plant and remove produce from the tree as the harvester moves along a plant row.

Mechanized harvesters, such as the one disclosed in U.S. Pat. No. 6,463,725, can be used on a variety of plants, such as fruit trees, for example. In industry, the fruit trees can be trimmed to remove the lowermost branches of the tree; commonly the fruit trees are trimmed approximately 36″ up from the ground. However, some produce trees are not trimmed and have lower branches on which a significant amount of fruit may be produced. Presently, mechanized harvesters do not engage the lowermost branches of the tree and may not harvest the fruit on the lowermost branches. In general, improvement has been sought with respect to such system, generally to increase harvest yield on untrimmed fruit trees.

### SUMMARY

In one embodiment, the present invention relates to a harvester for gathering produce from one or more plants. The harvester includes a frame, an agitator constructed to engage the plants for removing produce from the plants as the harvester moves in a first direction, a conveyor assembly, and a shaker device mounted adjacent to the conveyor assembly.

In another embodiment, the present invention relates to a shaker apparatus for a harvester. The shaker apparatus includes a shaker device having a longitudinal axis. The shaker device is configured to mount in an orientation that is substantially transverse to a direction of travel, and is configured to engage the lowermost branches of the plants as the shaker apparatus passes under the plant.

In yet another embodiment, the present invention relates to harvester for gathering produce from one or more plants, the harvester including a drive mechanism for advancing the harvester along a first direction. The harvester also includes an agitator having at least one whorl arrangement capable of rotating and engaging a plant to remove produce from the plant. The harvester further includes a retractable conveyor having a sealing arrangement mounted at an end of the conveyor. A shaker device is mounted adjacent to the conveyor and is constructed to engage the lowermost portion of the plant as the shaker device moves beneath the plant.

A variety of examples of desirable features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is front elevation view of one embodiment of a harvester showing a schematically represented shaker device positioned at a lower region of a tree, according to the principles of the present invention;

FIG. 2 is a top view of the harvester of FIG. 1;

FIG. 3 is a perspective view of a first embodiment of the shaker device schematically represented in FIG. 1 shown on a portion of the harvester, according to the principles of the present invention;

FIG. 4 is a perspective view of the shaker device of FIG. 3 shown with rotary elements in a first rotary position;

FIG. 5 is a perspective view of the shaker device of FIG. 4 shown with the rotary elements in a second rotary position; and

FIG. 6 is a side elevational view of a second embodiment of the shaker device schematically represented in FIG. 1, according to the principles of the present invention.

### DETAILED DESCRIPTION

Reference will now be made in detail to various features of the present invention that are illustrated in the accompanying drawings. Wherever possible, the same reference numbers will be used throughout the drawings to refer to the same or like parts.

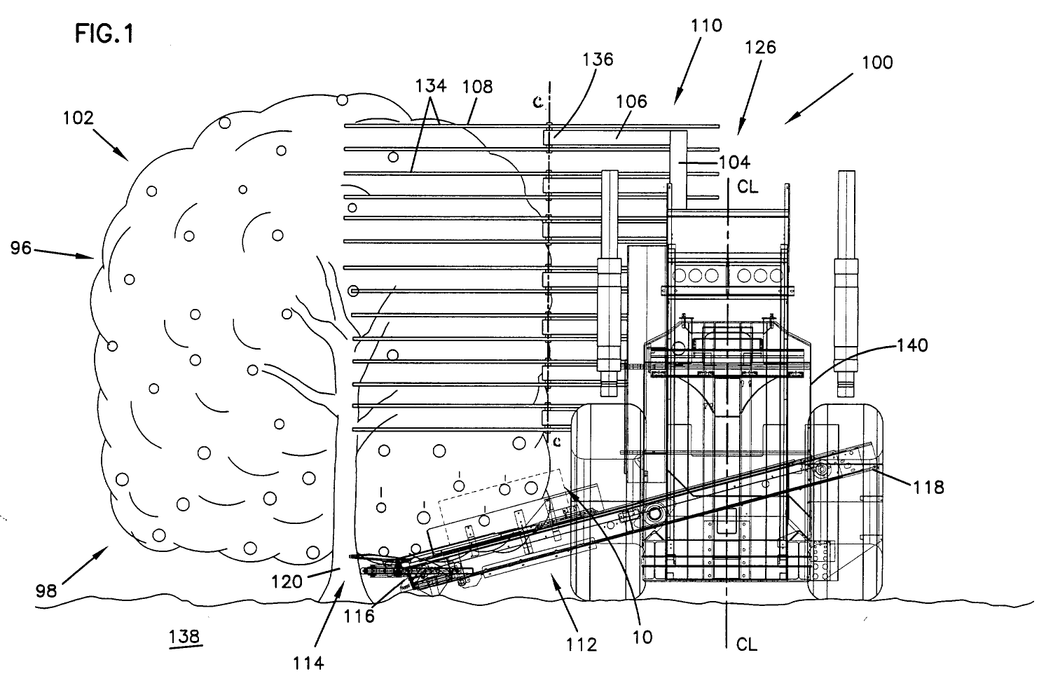

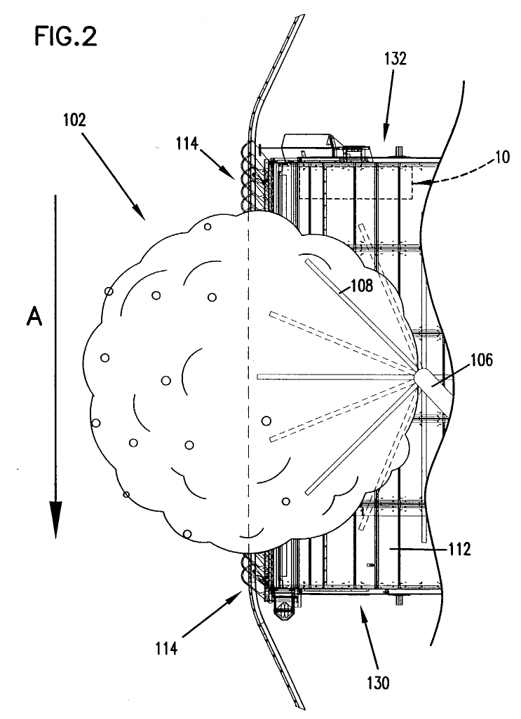

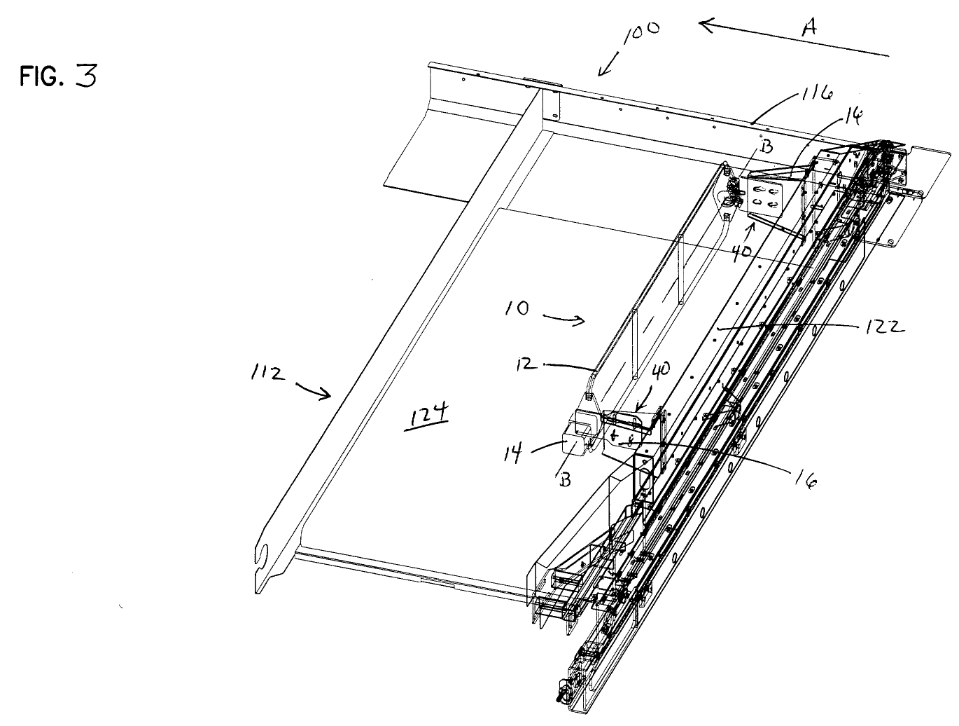

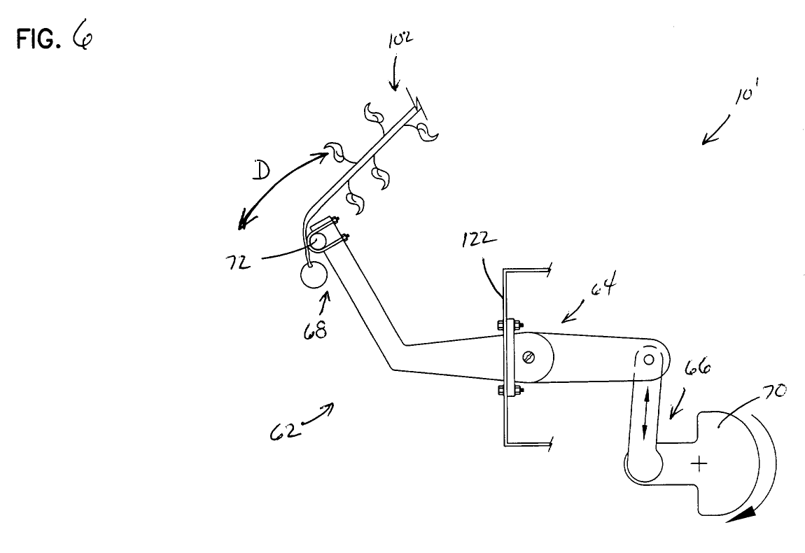

FIGS. 1-6 illustrate a shaker apparatus or shaker device, for use on a harvester, having features that are examples of how inventive aspects of the present invention may be practiced. In particular, FIGS. 1 and 2 illustrate a schematic representation of the shaker device shown on a harvester 100. FIGS. 3-5 illustrates a first embodiment of the shaker device 10. FIG. 6 illustrates a second embodiment of the shaker device 10′. The schematic representation of the shaker device in FIGS. 1 and 2 can incorporate various features of a variety of embodiments of the shaker device, including the first and second embodiments in FIGS. 3-6, in accord with the principles disclosed.

In general, FIGS. 1 and 2 illustrate one type of harvester 100 that can incorporate the present invention to increase the harvested produce yield from a plant 102. By way of illustration, the plant 102 shown in FIG. 1 is a citrus fruit tree, such as an orange or grapefruit tree. However, it should be understood that the harvester embodiment 100 shown in FIG. 1 is generally applicable to a variety of plants and trees, including various fruit trees as well as plants growing against a support structure, such as grapevines, or other similar plants or trees.

In the illustrated embodiment, the harvester 100 generally includes a frame 126 and a drive mechanism 140 such as a farm tractor or other similar machine capable of moving through a grove or orchard of fruit trees 102. The harvester 100 is typically constructed to harvest produce as it moves through a grove of fruit trees 102. In the embodiment illustrated in FIG. 1, a single harvester 100 is shown. However, the harvester 100 can work in conjunction with a second harvester (not shown) while harvesting produce from one or more trees 102 in cooperation with the harvester 100. In this embodiment, each harvester 100 moves along a row of trees 102 at substantially the same rate and on opposite sides of the same tree 102.

The illustrated harvester 100 includes a conveyor assembly 112 connected to the frame 126. The conveyor assembly 112 is used to convey harvested produce or fruit from a distal end 116 to a proximal end 118 of the conveyor assembly 112. The conveyor assembly 112 extends away from the harvester 100 so that the conveyor assembly 112 extends beneath the foliage of the tree 102. The conveyor assembly 112 is retractable and selectively positionable to adjust or correct the distance between the conveyor assembly 112 and a tree as the harvester 100 moves along a row of trees.

In other words, distance the conveyor assembly 112 extends from the harvester 100 may vary according to the spacing between a drive path along which the harvester travels and the tree, or may vary according to the spacing between the rows of trees 102 in the orchard or grove. For example, the conveyor assembly 112 is positionable such that the distal end 116 of the conveyor assembly 112 can be at least about 8 feet (about 2.4 meters), no more than about 13 feet (about 4.0 meters), and in a preferred embodiment approximately about 11 feet (about 3.4 meters) from the centerline CL (FIG. 1) of the harvester 100. Thus, in the one embodiment, the distance the retractable conveyor or arm 112 extends from the centerline CL of the harvester 100 can be optimized for harvesting produce from in an orchard or grove having a 24-foot spacing, for example.

Similarly, the conveyor assembly 112 has an overall width (see FIG. 2) suitable to catch produce from the tree 102 while minimizing the amount of lost produce. The overall width is defined between a first side 130 of the conveyor assembly and a second side 132. If used for citrus fruit trees, such as tree 102, the conveyor assembly 112 preferably has a width of at least about 15 feet (about 4.6 meters), no greater than about 30 feet (about 9.1 meters), and typically about 20-24 feet (about 6.1-7.3 meters). In a more preferred embodiment, the overall width is about 22 feet (about 6.7 meters). In the illustrated embodiment, the conveyor assembly 112 is wide enough to span beneath at least one or more trees 102 arranged in a row substantially parallel with a first direction or direction of travel (represented by arrow A in FIG. 2) of the harvester 100.

The harvester 100 is configured to remove produce from the tree 102 by shaking and/or agitating the foliage or branches of the tree 102. For example, in the embodiment shown in FIG. 1, the harvester 100 includes an agitator 110 having a vertical support shaft 104 and arm members 106. The arm members 106 are independently and rotatably mounted to the support shaft 104. The illustrated agitator 110 also includes whorl arrangements 134. The whorl arrangements 134 are rotatably mounted at or near a distal end 136 of the arm members 106. Each of the whorl arrangements is configured to rotate about a vertical axis C that is substantially perpendicular to the ground 138. The whorl arrangements 134 include fingers 108 that engage the tree 102 and forcibly remove the fruit or produce from the tree 102 as the harvester 100 moves along the direction of travel A.

The illustrated harvester 100 also includes a sealing arrangement 114 configured to maintain a seal between the harvester 100 and the tree 102. Specifically, the sealing arrangement 114 maintains the distal end 116 of the conveyor assembly 112 a predetermined distance from a lower trunk 120 of the tree 102. As a result, a seal is maintained between and the tree trunk 120 the distal end 116 of the conveyor assembly 112 to catch and direct fallen produce toward the conveyor assembly.

Still referring to FIG. 1, the fruit tree 102 illustrated is an untrimmed fruit tree having an upper region 96 and a lower region 98. The agitator 110 operates to remove or harvest fruit from the upper region 96 of the tree 102, however, the agitator 110 does not typically engage the lowermost branches on the untrimmed trees and does not remove or harvest fruit from the lower region 98 of the tree 102. Thus, a significant amount of fruit is left in the lower region 98 of the tree 102. In conventional operations, the fruit remaining in the lower region 98 of untrimmed trees must be either handpicked, or remain on the trees unharvested.

The present invention relates to shaker device 10 used to remove fruit from the lower region 98 of an untrimmed tree 102. The shaker device 10, schematically represented in FIGS. 1 and 2, is positioned along the conveyor assembly 112 such that the fruit unharvested by the agitator 110 is forcibly removed from the foliage of the tree 102 by the shaker device 10 as the harvester 100 advances in the direction of travel A.

Referring now to FIGS. 3-5, the first embodiment of the shaker device 10 is illustrated. The shaker device 10 generally includes a beater or rotary member 12 defining a longitudinal axis B and a drive or motor 14 configured to rotate the rotary member 12 about the longitudinal axis B. In the illustrated embodiment, the shaker device 10 is mounted adjacent to the conveyor assembly 112 of the harvester 100 by mounting brackets 16.

In use, the shaker device 10 is typically oriented such that the longitudinal axis B of the shaker is transverse to the direction of travel A. In the illustrated embodiment, the shaker device extends longitudinally and substantially parallel to an upper table surface or conveyor deck 124 of the conveyor assembly 112. It is contemplated that the shaker device 10 can also be oriented in a non-parallel orientation relative to the conveyor deck 124 as desired to vary the engagement with a tree.

As shown in FIGS. 1 and 2, the shaker device 10 is located at the trailing side or second side 132 of the conveyor assembly 112. The shaker device 10 in the illustrated embodiment is configured to mount to a sidewall 122 above the conveyor deck 124 of the conveyor assembly 112 in an orientation generally parallel with the conveyor deck 124.

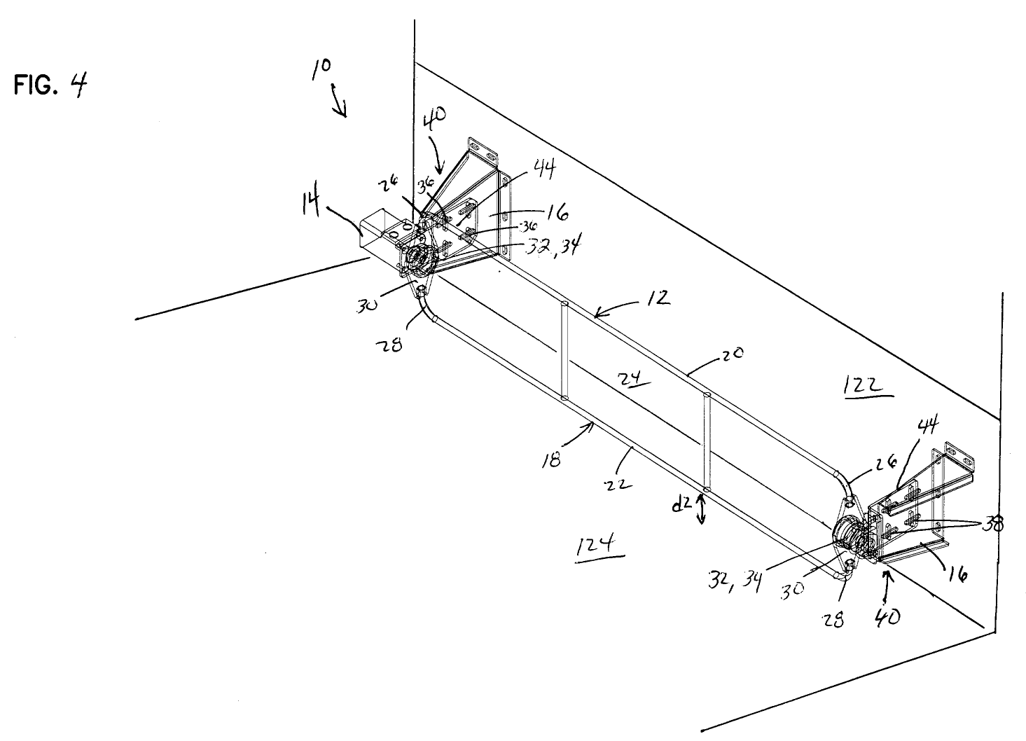

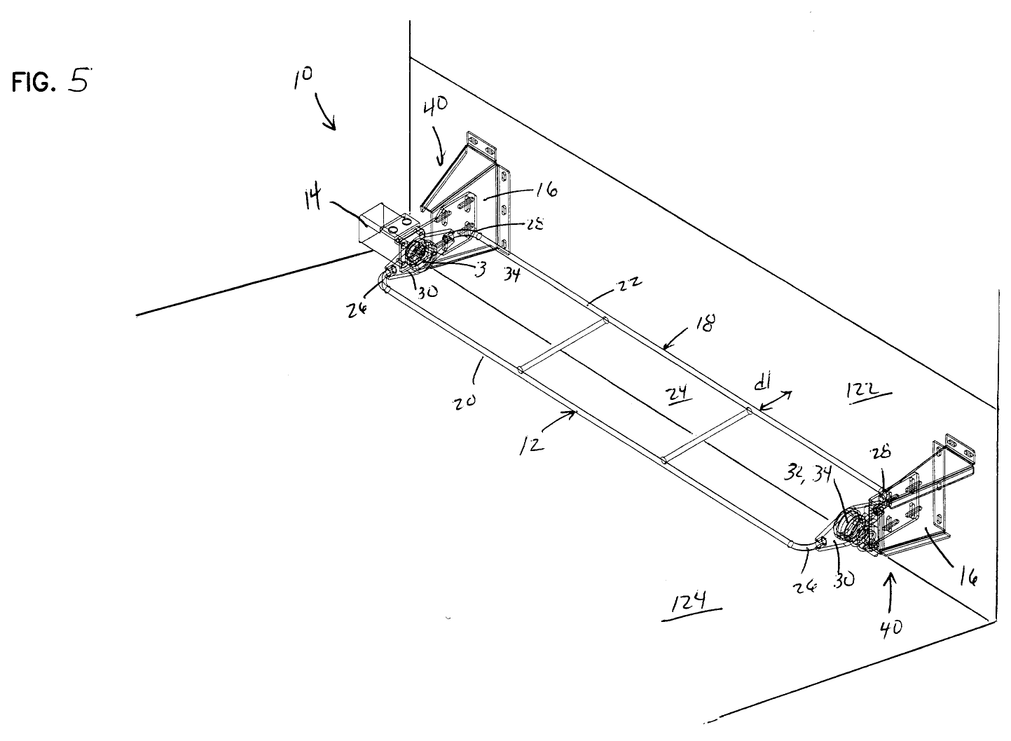

Preferably, the shaker device 10 is positioned to provide adequate clearance between the rotary member 12 of the shaker device 10 and the sidewall 122 so that fruit removed from the tree is permitted to pass between the rotary member 12 and the sidewall 122 without obstruction (see FIG. 5 showing the rotary member 12 in a horizontal rotary position). Likewise, the shaker device 10 is preferably positioned to provide adequate clearance between the rotary member 12 and the conveyor deck 124 of the conveyor assembly 112 so that fruit removed from the tree 102 is permitted to pass between the rotary member 12 and the conveyor deck 124 without obstruction (see FIG. 4 showing the rotary member 12 in a vertical rotary position).

In particular, the rotary member 12 is positioned a first distance d1 (FIG. 5) from the sidewall 122 and a second distance d2 (FIG. 4) from the conveyor deck 124. It is contemplated that the first distance d1 can be greater than, less than, or equal to the second distance d2, depending upon the type of produce or crop being harvested. In the illustrated embodiment, oranges are being harvested. For typical sized oranges, the first distance d1 and the second distance d2 are each approximately 6 inches (15 cm) from the respective sidewall 122 and the conveyor deck 124. Preferably, the shaker device 10 includes an adjustable mounting arrangement 40, described in greater detail hereinafter, to permit use of the shaker device 10 in a variety of harvesting applications.

Referring now to FIGS. 4 and 5, the rotary member 12 of the shaker device 10 includes rotary elements 18. The rotary elements 18 can include bars or rods having a variety of cross-sectional configurations, including a varying cross-sectional configuration such as a tapering bar or rod. It is also contemplated that the rotary elements 18 can include other structure, such as flattened paddles or tines/fingers, for example, configured to forcibly remove produce from a tree. The illustrated rotary member 12 defines a cylindrical shape as the rotary member 12 revolves. It is contemplated that the rotary member 12 may include bent or other shaped elements that define alternative volumetric shapes as the rotary member revolves, such as a tapering cylindrical shape or a conical shape, for example.

In the illustrated embodiment, the rotary elements 18 include a first rod 20 and a second rod 22 positioned apart from one another. The first rod 20 is positioned approximately 180 degrees apart from the second rod 22. It is contemplated that the rotary member 12 can include only a single rotary element, or more than two rotary elements spaced apart from each other. Preferably the rotary elements 18 are configured such that an open region 24 is defined between the rotary elements through which produce is permitted to pass when falling from the tree 102.

The first and second rods 20, 22 of the rotary member 12 have bent ends 26, 28 configured to couple to a mounting plate 30. The bent ends can be configured in a variety of lengths to extend the reach of the rotary member 12 and increase the open region 24 through with produce can pass. The mounting plates 30 couple to hubs 32 of the shaker device 10. The hubs 32 include bearings 34 to accommodate the rotational motion of the rotary member 12. One of the hubs 32 includes drive structure that couples with the drive or motor 14 of the shaker device 10.

Preferably, the shaker device 10 is selectively set to rotate in a direction opposite the direction of travel A. That is, the rotary member 12 rotates in a backward direction if the harvester 100 is moving forward along the direction of travel A (FIG. 2). It is contemplated that the rotary member 12 can be configured to rotate in a forward direction along with a forward movement of a harvester, however, opposite rotation (in the backward direction) has provided greater harvesting yields in field tests. In typical use, the rotary member 12 is operated at a speed of about 300 to 600 revolutions per minute, but can be operated at other speeds depending upon the harvesting application.

Preferably, the shaker device 10 is configured to rotate in either a clockwise direction or a counter-clockwise direction. This configuration allows the shaker device 10 to be mounted on either the right-hand side of the harvester 100 or the left-hand side of the harvester 100, (depending on the location of the conveyor assembly 112), while still providing rotation in a backward direction.

Still referring to FIG. 4, the hubs 32 of the shaker device 10 are coupled to intermediate brackets 44, which are in turn coupled to the mounting brackets 16. As shown in FIG. 4, the intermediate brackets 44 include slots 36. The slots 36 in the illustrated embodiment extend in a generally vertical orientation. The mounting brackets 16 also include slots 38. The mounting bracket slots 38 extend in a generally horizontal orientation. The intermediate bracket slots 36 and the mounting bracket slots 38 define one embodiment of the adjustable mounting arrangement 40. The adjustable mounting arrangement 40 permits a user to adjust the distance d1 between the rotary member 12 and the sidewall 122, and adjust the distance d2 between the rotary member 12 and the conveyor deck 124 to adapt to different harvesting applications. Other adjustable mounting arrangements can be used, such arrangements including pin slot arrangements and hole pattern arrangements, for example.

Referring now to FIG. 6, the second embodiment of the shaker device or shaker device 10′ is illustrated. In this embodiment, the shaker device 10′ includes a beater or reciprocating member 62. A tube or rod 72 is attached to the reciprocating member 62. The shaker device 10′ can include a single reciprocating member 62 or more than one reciprocating members interconnected by the bar or rod 72.

The reciprocating member 62 includes a linkage arrangement 64 having a first end 66 and a second end 68. A drive member 70 is interconnected to the linkage arrangement 64 at the first end 66. The bar 72 is interconnected to the linkage arrangement 64 at the second end 68. The drive member 70 operates to cause the second end 68 and the bar 72 to reciprocate as shown by arrow D. The reciprocating motion of the bar 72 shakes the lower branches of the trees to forcibly remove produce from the tree as the shaker device 10 and harvester 100 moves along the direction of travel A (FIG. 2).

In operation, each embodiment of the shaker device 10, 10′ is designed to remove produce or fruit that is not removed from the lower hanging branches by a primary agitator (e.g. 110) of a harvester 100. Conventional agitators are not configured to adequately shake the all the branches of untrimmed trees. As a conveyor assembly configured with the present shaker device 10, 10′ passes under a lower region 98 of a tree 102, the shaker device 10, 10′ contacts the lowermost branches causing a shaking action that forcibly removes the remaining fruit. In some instances, the shaker device 10, 10′ contacts the fruit to sever the fruit from the branches. The fruit is then deposited on the conveyor deck 124 of the conveyor assembly 112 and can be transported to a harvester's cleaning system or hopper.

The above specification provides a complete description of the TREE SHAKER APPARATUS. Since many embodiments of the invention can be made without departing from the spirit and scope of the invention, the invention resides in the claims hereinafter appended.

1. A harvester for gathering produce from one or more plants, the harvester comprising:
a frame;
an agitator constructed and arranged to engage the plants for removing produce from the plant as the harvester moves in a first direction, the agitator defining a first axis of rotation;
a conveyor assembly;
a shaker device mounted adjacent to the conveyor assembly, the shaker device defining a second axis of rotation, the second axis of rotation being non-parallel to the first axis of rotation.

2. A harvester according to claim 1, wherein the agitator is arranged to remove produce from an upper region of the plant and the shaker device is arranged to remove produce from a separate lower region of the plant.

3. A harvester according to claim 1, wherein the shaker device is mounted above a deck surface of the conveyor assembly.

4. A harvester according to claim 3, wherein the shaker device is mounted above the deck surface a distance sufficient to permit produce to pass between the shaker device and the deck surface.

5. A harvester according to claim 3, wherein the shaker device is mounted on a sidewall, the shaker device being configured to permit fruit to pass between the shaker device and the sidewall.

6. A harvester according to claim 5, wherein the shaker device includes an adjustable mounting arrangement configured to adjustment clearance distances between the shaker device and each of the deck surface and the sidewall.

7. A harvester according to claim 6, wherein the adjustable mounting arrangement includes first and second mounting brackets, each of the first and second mounting brackets including slots to adjust the clearance distances between the shaker device and each of the deck surface and the sidewall.

8. A harvester according to claim 1, wherein the shaker device has a longitudinal axis transverse to the first direction.

9. A harvester according to claim 1, wherein the shaker device extends longitudinally substantially parallel to an upper surface of the conveyor assembly.

10. A harvester according to claim 1, wherein the shaker device comprises a rotatable beater.

11. A harvester according to claim 1, wherein the shaker device comprises a reciprocating beater.

12. A harvester according to claim 10, wherein the beater comprises at least one rod.

13. A harvester according to claim 12, wherein the rotatable beater comprises a pair of spaced apart rods.

14. A harvester according to claim 1, wherein the shaker device is configured to extend under and engage the lowermost branches of a plant.

15. A harvester according to claim 1, wherein the shaker device is configured to rotate in a backward direction opposite the first direction.

16. A harvester according to claim 1, wherein the shaker device is configured to selectively rotate in either a clockwise direction or a counter-clockwise direction.

17. A shaker apparatus that mounts to a harvester for removing produce from a plant as the harvester moves in a direction of travel, the shaker apparatus comprising:
a shaker device having a longitudinal axis, the shaker device being configured to mount to a harvester in an orientation whereby the longitudinal axis extends in a lateral direction outward from the harvester and is substantially transverse to the direction of travel, the shaker device being configured to engage the lowermost branches of a plant as the shaker apparatus passes under the plant.

18. A shaker apparatus according to claim 17, wherein the shaker device is configured to mount adjacent to a deck of a conveyor assembly.

19. A shaker apparatus according to claim 17, wherein the shaker device is configured to extend substantially parallel to the deck of the conveyor assembly.

20. A shaker apparatus according to claim 17, wherein the shaker device comprises a rotatable beater.

21. A shaker apparatus according to claim 17, wherein the shaker device comprises a reciprocating beater.

22. A shaker apparatus according to claim 17, wherein the shaker device comprises at least one rod.

23. A shaker apparatus according to claim 22, wherein the shaker device comprises a pair of spaced apart rods.

24. A shaker apparatus according to claim 17, wherein the shaker device is configured to rotate in a first direction and in a second opposite direction.

25. A shaker apparatus according to claim 17, further including an adjustable mounting arrangement that permits adjustment of a clearance distance when mounted to a surface.

26. A harvester for gathering produce from one or more plants, the harvester comprising:
a harvester frame;
a drive mechanism for advancing the harvester along a first direction relative to the plants;
an agitator constructed and arranged to engage the plant and remove produce from the plant as the harvester moves in the first direction, wherein the agitator comprises at least one whorl arrangement capable of rotating about a vertical axis substantially perpendicular to the ground surface upon which the harvester travels; each of the whorl arrangements being capable of rotating and engaging the plants and forcibly removing produce from the plant as the harvester moves in the first direction;
a retractable conveyor mounted to and extending outward from a side of the harvester frame towards the plant;
a sealing arrangement mounted at a distal end of the retractable conveyor;
a shaker device mounted adjacent to the conveyor, the shaker device being arranged to engage a lowermost portion of the plant and remove produce from the plant as the shaker device moves beneath the plant.

27. The shaker apparatus according to claim 17, further including at least one elongated member configured to at least partially rotate about an axis of rotation, the axis of rotation being parallel to the longitudinal axis of the shaker device.

28. The shaker apparatus according to claim 27, wherein the axis of rotation is co-linear with the longitudinal axis of the shaker device.

29. A harvester for gathering produce from one or more plants, the harvester comprising:
a frame;
an agitator including a first number of agitator engagement members arranged to engage the plants for removing produce from the plant as the harvester moves in a first direction;
a conveyor assembly;
a shaker device mounted adjacent to the conveyor assembly, the shaker device including a second number of shaker engagement members arranged to engage the plants for removing produce from the plant as the harvester moves in the first direction, the second number of shaker engagement members being different than the first number of agitator engagement members.
